(19) United States
(12) Patent Application Publication
(10) Pub. No.: US 2017/0317832 A1
(43) Pub. Date: Nov. 2, 2017

(54) Virtual Secure Elements in Computing Systems based on ARM Processors

(71) Applicant: Oleksii Surdu, Broadlands, VA (US)

(72) Inventor: Oleksii Surdu, Broadlands, VA (US)

(21) Appl. No.: 15/069,368

(22) Filed: Mar. 14, 2016

(51) Int. Cl. H04L 9/32; G06F 21/53

(52) U.S. Cl. CPC H04L 9/3234; G06F 21/53; G06F 2221/2149

(57) ABSTRACT

The invention comprises a computer system which is based on ARM processors (for example, popular mobile devices and Chromebooks), wherein the ARM processor provides fully hardware-isolated runtime environments for an operating system (OS) and Trusted Execution Environment (TEE) with multiple virtual secure elements (VSE's). The isolation is performed by hardware ARM Security Extensions added to ARMv6 processors and higher and controlled by VSE software. The invention therefore comprises multiple managed VSE's running in the TEE on one or more processor cores with dedicated memory and storage and used to provide a secure element function in a computer system even without a separate hardware secure element. The invention provides security for applications like payment methods without need to integrate the hardware secure element.

In addition, embodiments of the invention do not require any modification to the OS system code or application software such as for example, a payment application.

We claim the benefit of provisional application #6228062.

### FIELD OF THE INVENTION

The present invention generally relates to endpoint computer security and more particularly, payment solutions on mobile devices or other ARM processor-based computers whose security is enhanced by providing a VSE using particular ARM processor Security Extensions.

Current mobile devices such as tablets or smart phones often implement payment solutions in a device without hardware secure elements, and instead employ a software-only solution. This architecture generally poses a high risk for payment information when the mobile device is compromised by malware. The present invention particularly addresses the threat of unauthorized access to payment information on a mobile device, providing security advancement without need for hardware secure elements, and therefore making advanced security available to a wide range of mobile devices, especially lower cost devices, not containing hardware secure elements but for which the product provider wishes to include strong payment or other app security. The present invention thus particularly addresses threats of unauthorized access to payment information and cryptographic keys in the scenario where a fully-featured “Rich” OS is compromised. In such a scenario, the hardware-protected VSE remains secure and optionally can be erased remotely.

VSE's are running in TEE on one or more cores with dedicated memory and storage. Any access to the VSE is limited to standard protocols. Internal VSE data and cryptographic keys are not accessible from Rich OS Execution Environment.

### RELATED ART

The following references identify related art:
[1] Brudnicki, Craft, Reisgies, Weinstein, “System And Method For Providing A Virtual Secure Element On A Portable Communication Device”, U.S. Patent Application US 2012/0124394 A1, May 17, 2012.
[2] Mellqvistm, “Portable Electronic Devices, Systems, Methods And Computer Program Products For Accessing Remote Secure Elements”, U.S. Patent Application US 2010/0153721 A1, Jun. 17, 2010.
[3] Rfcyber Corp, “Method And Apparatus For Emulating Multiple Cards In Mobile Devices”, U.S. Patent Application US 2013/0178159 A1, Jul. 11, 2013.
ARM Architecture Reference Manuals: http://infocenter.arm.com/help/index.jsp?topic=/com.arm.doc.ddi0406c/index.html
ARM Cortex-A series processor Technical Reference Manuals: http://infocenter.arm.com/help/index.jsp?topic=/com.arm.doc.ddi0388e/index.html
CoreLink TrustZone Address Space Controller TZC-380 Technical Reference Manual: http://infocenter.arm.com/help/index.jsp?topic=/com.arm.doc.ddi0431c/index.html
PrimeCell Infrastructure AMBA 3 TrustZone Protection Controller Technical Overview: http://infocenter.arm.com/help/index.jsp?topic=/com.arm.doc.dto0015a/index.html
i.MX 6Dual/6Quad Applications Processor Reference Manual: http://cache.freescale.com/files/32bit/doc/ref_manual/IMX6DQRM.pdf?fasp=1&WT_TYPE=Reference%20Manuals&WT_VENDOR=FREESCALE&WT_FILE_FORMAT=pdf&WT_ASSET=Documentation&fileExt=.pdf

### BACKGROUND OF THE INVENTION

The ARM Security Extensions extend the processor architecture to provide hardware security features that support the development of secure applications, by providing two processor security states. Rich OS Execution Environment runs in Normal World when the processor is in a Non-secure state. A TEE and its trusted applications are running in Secure World when the processor is in a Secure state. The most important system control resources are only accessible from the TEE. Each security state has its own system registers and memory address space. The execution privilege levels are defined independently in each security state.

Some of the ARM processor implementations do not include the Security Extensions. The present invention is applicable only to computer systems based on ARM processors with Security Extensions.

While the main purpose of ARM Security Extensions is isolation between Normal and Secure Worlds, the present invention provides an innovative approach for using these Security Extensions to isolate and protect VSE without a dependency on a separate hardware secure element.

In order to achieve memory separation between two execution environments, memory access rights are configured through the ARM Memory Management Unit (MMU) (see ARM Cortex-A series processor Technical Reference Manuals), TrustZone Address Space Controller (TZASC) (see CoreLink TrustZone Address Space Controller TZC-380 Technical Reference Manual), and TrustZone Protection Controller (TZPC) (see PrimeCell Infrastructure AMBA 3 TrustZone Protection Controller Technical Overview) or through vendor specific Security Extension hardware modules, for example Central Security Unit (CSU) in iMX6 Freescale processor (see i.MX 6Dual/6Quad Applications Processor Reference Manual).

A Secure Monitor Call (SMC) is available only from software executing at Non-secure PL1 mode or higher. A SMC is always taken to Secure Monitor mode. Interrupt Requests (IRQ), Fast Interrupt Requests (FIQ), and External abort exceptions can be configured to be taken to Secure Monitor mode.

The most common memory access control mechanism is the MMU and it is currently used in all popular OSs to separate system and user applications memory. The ARM processor enhanced with Security Extensions has a separate and independent MMU for Secure and Normal World execution environments.

The purpose of a TZASC module is separation of TEE memory from Rich OS Execution Environment. It works with random-access memory (RAM) only and can be configured from TEE only. As the MMU, it divides memory into regions and each region has its own memory access control attributes. The TZASC works independently of MMU even when MMU is disabled. The TZASC works with physical addresses and doesn't have any MMU virtual address awareness.

Since the TZASC module works only with RAM, the TZPC is used to control access between Rich OS Execution Environment and TEE. Also TZPC can be used to control on-chip RAM access control in some ARM processors implementations. The TZPC could be configured from TEE only. Different ARM processors have different peripheral devices and interfaces, so TZPC regions are predefined and implementation dependent, and only access rights to these regions can be changed in the runtime.

### BRIEF DESCRIPTION OF THE DRAWINGS

FIG. 1 (background art) illustrates ARMv6 and greater processors Privilege Levels (PL), processor modes and types of software running with corresponding privileges.

FIG. 2 illustrates the high level model of the invention. VSE's with management service are running inside TEE. Access to internal VSE data is allowed from TEE only. All requests from a Rich OS which is running in Normal World to VSE goes through security checks performed in TEE.

FIG. 3 illustrates a more detailed view of TEE. All critical parts of the management system are located inside TEE. Cryptographic keys used in VSE's are accessible from TEE only.

FIG. 4 describes a VSE data storage model with access control based protection.

FIG. 5 illustrates a VSE data storage model with cryptographic based protection. Cryptographic keys are accessible by the TEE software only.

### DETAILED DESCRIPTION

Preferred embodiments of the present invention should have a hardware-enforced trusted execution environment and secure boot procedure.

This can be achieved using a secure system boot loader mechanism that is currently implemented in most ARM processors and described in prior art, for example in Patent No. US20090204801A1. Such a system based on ARM processors uses a first stage system boot loader that is located inside on-chip read-only memory (ROM) to ensure integrity and authenticity of the external boot code and prevents system start using unauthorized code. This creates a trusted computing base where after boot completion, the system is in determined state that cannot be altered.

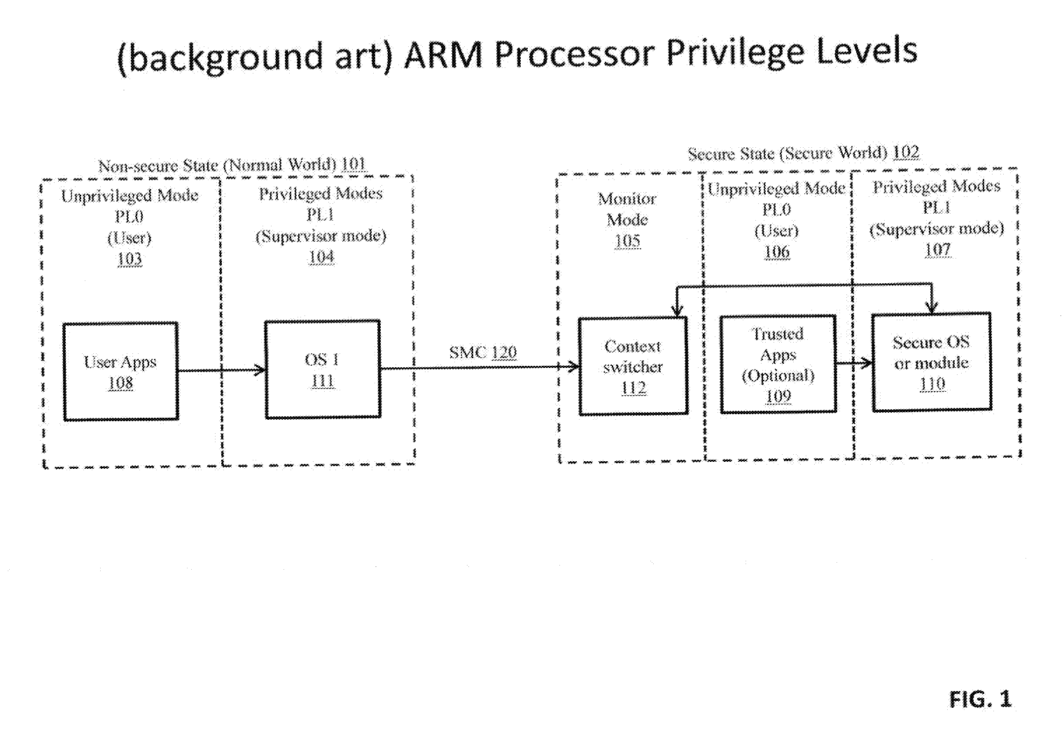

FIG. 1 (background art) illustrates ARMv6 and greater processors Privilege Levels (PL), processor modes and types of software running with corresponding privileges (see ARM Architecture Reference Manuals). The ARM CPU architecture supports multiple PL that number from the lowest PL, the Non-secure state PL0 (103) that is often described as Unprivileged or User mode.

Every memory access has corresponding access privilege. For example, software executing at PL0 privilege level makes only unprivileged memory accesses. Software executing at PL1 (104) makes privileged memory accesses by default, but can also make unprivileged access.

The ARM Security Extensions extend the processor architecture to provide hardware security features that support the development of secure applications, by providing two processor security states. Common OS (111) and User applications (108) are running in Normal World when the processor is in Non-secure state (101). A Secure OS or module (110) and its trusted applications (109) are running in Secure World when the processor is in Secure state (102). The most important system control resources are only accessible from the Secure World.

Software executing at privileged modes in the Non-secure state PL1 (104) can access the most features of the ARM processor, and can change the configuration settings for those features, except for some features added by the Security Extensions that are only accessible at PL2 or in Secure state.

Each security state has its own system registers and memory address space. The execution privilege levels are defined independently in each security state. There is no relationship between the Secure PL0 (106), Secure PL1 (107) and between Non-secure PL0 (103) and Non-secure PL1 (104) privilege levels.

The Monitor mode (105) exists only in the Secure state, and supports transitions between Secure and Non-secure state. Software Context switcher (112) running in Monitor mode has access to both the Secure and Non-secure copies of system registers.

A Secure Monitor Call (SMC) is available only from software executing at Non-secure PL1 mode or higher. A SMC (120) is always taken to Secure Monitor mode. Interrupt Requests (IRQ), Fast Interrupt Requests (FIQ), and External abort exceptions can be configured to be taken to Secure Monitor mode.

Secure PL1 mode can change the configuration and control settings for Non-secure operation in all modes, but Non-secure modes can never change the configuration and control settings for Secure World.

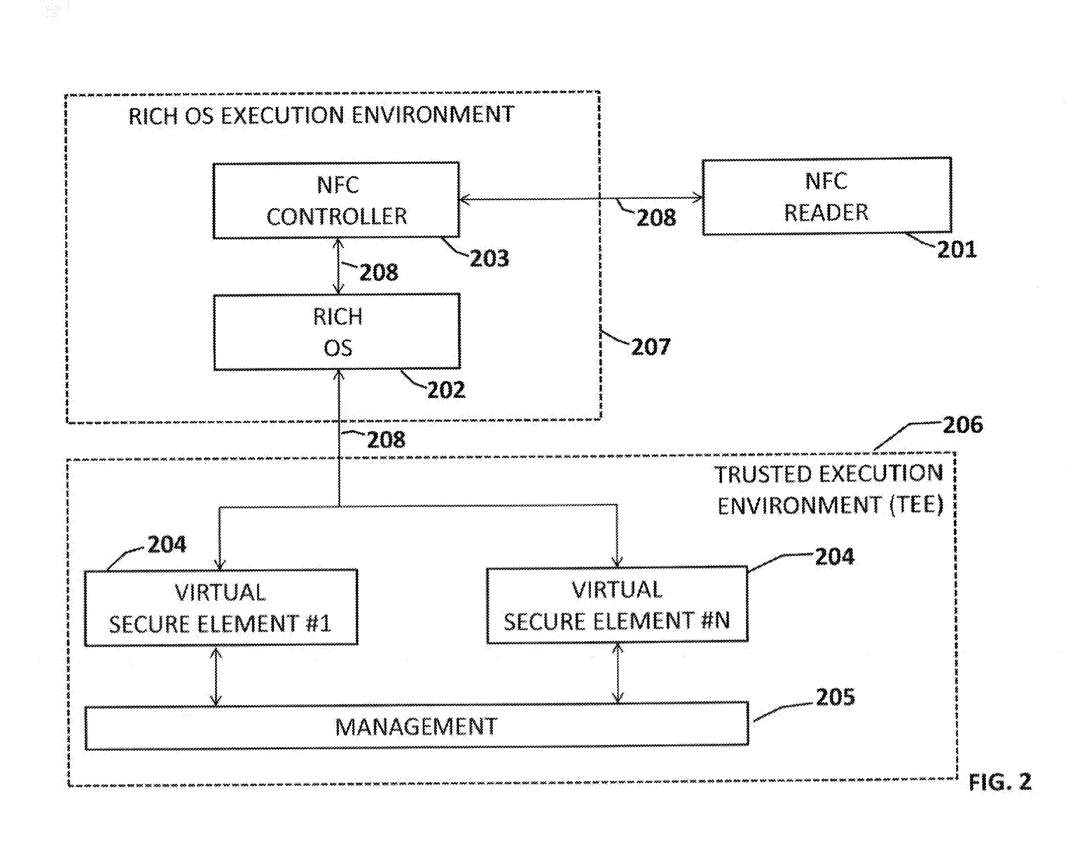

FIG. 2 illustrates the high level model of the present invention where requests from NFC Reader (201) go to the NFC Controller (203) and then are forwarded to one of the VSE (204) running in Secure World TEE (206) through Rich OS (202) running in Normal World Execution Environment. Data exchange in the communication channels (208) should be encrypted for security purposes.

The described approach does not require any modification to the OS system code or payment application software.

As an example of VSE's in a mobile device, U.S. Patent Application US 2012/0124394 A1 may be used. The referenced embodiment describes a VSE in a mobile device with a hardware secure element and uses device memory to work with VSE. The present invention does not depend on a hardware secure element and executes VSE in TEE protected by security extensions of the hardware platform. A software running in Normal World (Rich OS Execution Environment (207)) does not have any access to TEE memory.

Management service (205) runs in Secure World TEE also and provides a functionality to create, manage and erase the VSE.

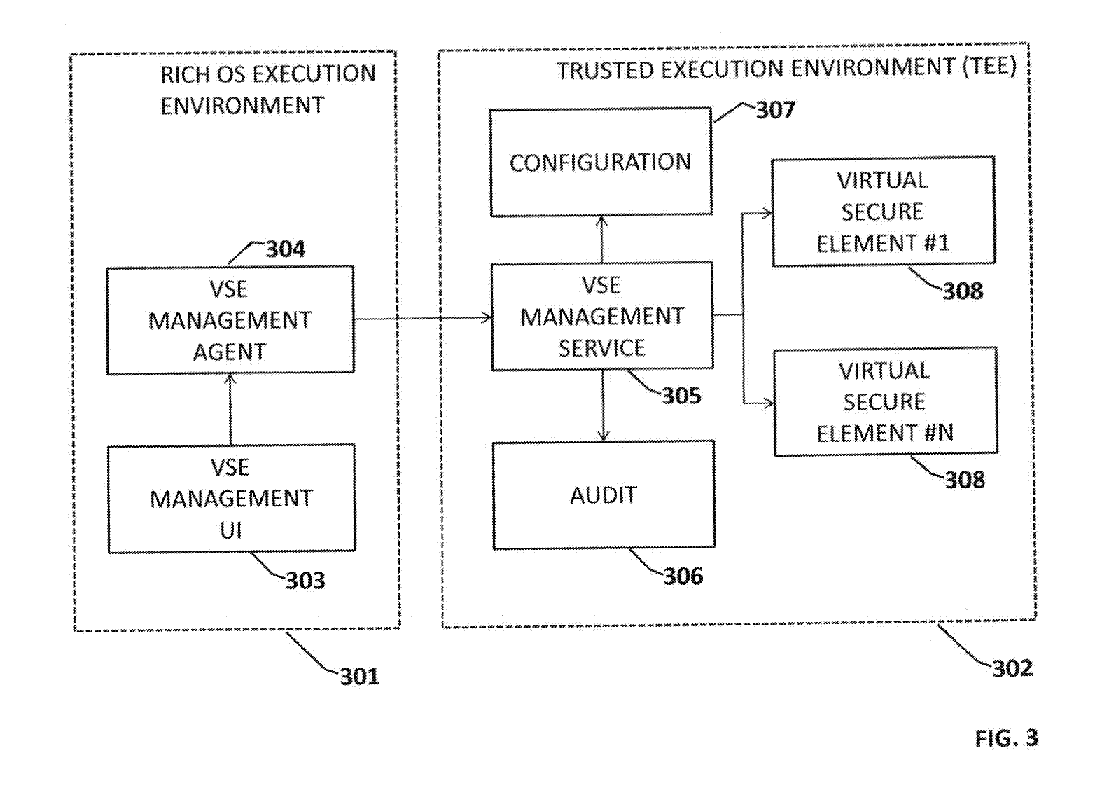

FIG. 3 illustrates a detailed model of the TEE. The VSE (308) is running inside TEE (302). VSE Management Service (305) controls all VSE's and provides additional features such as configuration management (307) and audit (306).

All critical parts (305-308) of the present invention are located inside the TEE (202). Non-critical parts (303, 304) of the management system are located in the Rich OS Execution Environment (301). VSE Management UI (303) provides a user with a tool to interact with VSE Management Service (305) where the user can locally view or modify some of settings.

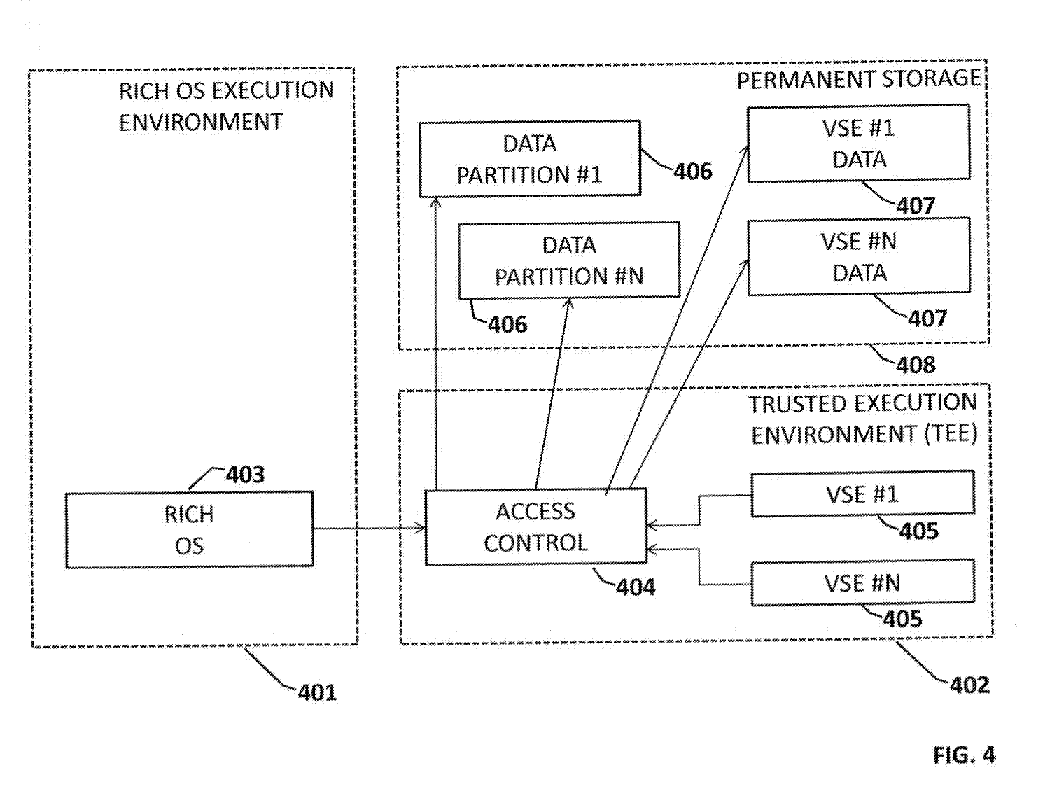

FIG. 4 illustrates a VSE data storage model with access control protection. Both data partitions (406) and VSE data (407) are stored in the permanent storage (408). Security checks are performed by the access control service (404) running inside TEE (402). VSE (405) can access only its own private data (407). Access to the VSE data is not allowed for other VSEs or Rich OS (403). The Rich OS (403) running in Rich OS execution environment (401) and cannot have direct hardware access to permanent storage. The Rich OS can access generic data partitions (406) only through access control service.

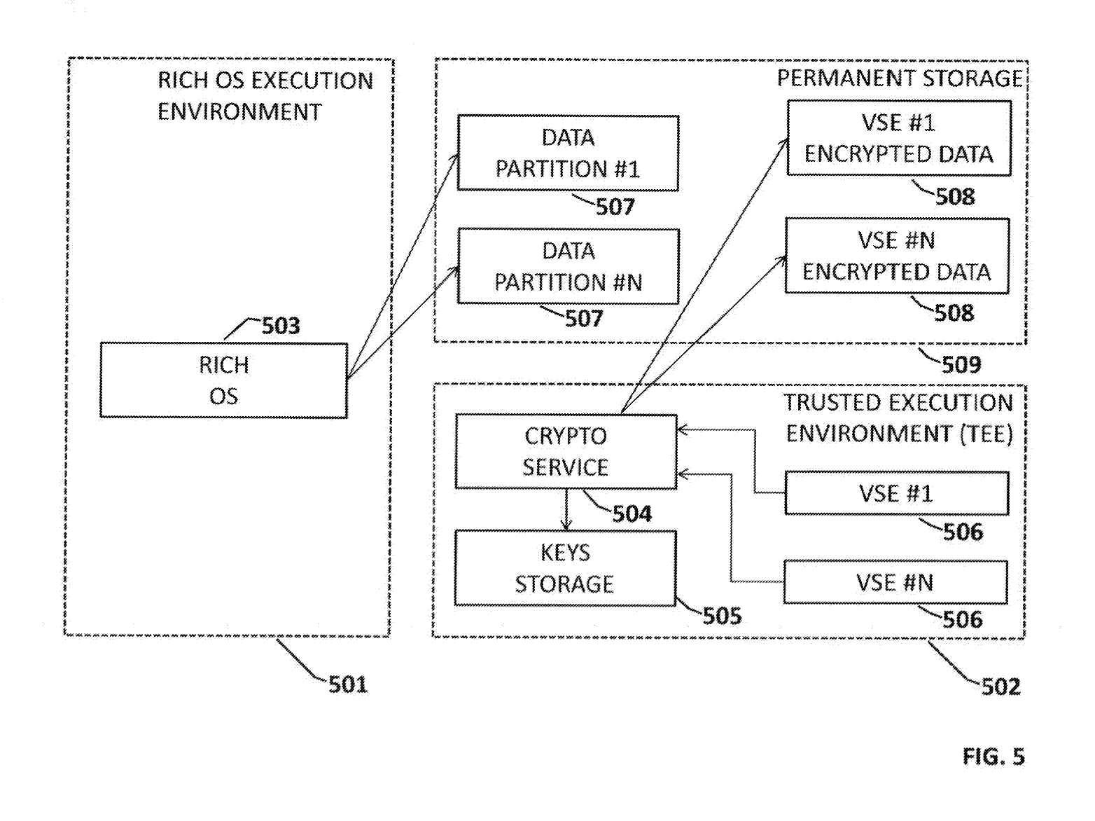

FIG. 5 illustrates a VSE data storage model with cryptographic based protection. Rich OS (503) running in Rich OS execution environment (501) has a direct hardware access to permanent storage (509) and its generic data partitions (406). VSE data (508) is stored in encrypted form as a file or a separate partition in the permanent storage.

Crypto service (504) is responsible for encryption/decryption of the VSE data. VSE (506) can access only its own private data. Each VSE data set is protected using a dedicated set of cryptographic keys stored in the keys storage (505). Cryptographic keys are accessible by the crypto service inside TEE (502) only.

Various modifications may become apparent to those skilled in the art, such as combination of the access control and cryptographic based protection methods of VSE data described above.

Access control modules utilizes ARM processor Security Extensions such as TZPC or hardware Virtualization Extensions to control access level to particular hardware resources such as internal hardware devices, hardware interfaces and external peripheral devices from OS's that are running in the Normal World.

Security Extensions of current ARM processors allow isolated runtime environments to be established using the method presented in this invention.

General purpose RAM access control is configured through TZASC and MMU. The memory region access control for hardware interfaces is configured through TZPC. In the present invention memory access control is used for separation of runtime execution environments.

We claim:

1. A computing system with a virtual secure element that provides capabilities of an embedded secure element comprising:
a. a computer system based on an ARM processor with integrated Security Extensions;
b. the virtual secure element running in a Trusted Execution Environment (TEE) with dedicated memory;
c. an OS running in a Rich OS Execution Environment with dedicated memory;
d. a TEE and Rich OS Execution Environment that are hardware isolated from each other using Security Extensions of the hardware platform;
e. access to the internal data of the virtual secure element allowed from the TEE only;
f. a virtual secure element controlled by management service;
g. management service used in local or remote mode;

2. The computing system as claimed in claim 1 where software running in the TEE performs access control to the virtual secure element and its internal data.

3. The computing system as claimed in claim 1 where internal data of the virtual secure element is protected using cryptographic methods by the software running in TEE.
